(19) United States
(12) Patent Application Publication
(10) Pub. No.: US 2013/0212611 A1
(43) Pub. Date: Aug. 15, 2013

(54) USER DIRECTED CUSTOMIZED ADJUSTABLE CONTENT INSERTION

(71) Applicants: Troy Van Aacken, Atlanta, GA (US); Quoc Vu, Marietta, GA (US)

(72) Inventors: Troy Van Aacken, Atlanta, GA (US); Quoc Vu, Marietta, GA (US)

(73) Assignee: AVA TECHNOLOGY VENTURES, LLC, Atlanta, GA (US)

(21) Appl. No.: 13/371,444

(22) Filed: Feb. 12, 2012

(51) Int. Cl. H04N 21/23; H04N 21/254

(52) U.S. Cl. 725/23; 725/34

(57) ABSTRACT

Methods, systems, and apparatuses can operate to provide user directed third party video content. In some implementations, a first segment of third party video content is provided to a user device for display to the user, and a request is received from the user to skip the first segment of third party video content. A second segment of third party video content is retrieved and provided to the user device for display to the user.

### TECHNICAL FIELD

This disclosure relates to content insertion into video programs.

### BACKGROUND

Video programming has a long history of inserting third party content into the video stream during predefined periods of time. These predefined periods of time are typically sold to third party content providers based upon a variety of factors. These factors can include the content subject matter, a size associated with a segment of third party content, a size associated with an avail, a projected impressions for the avail, and the identity of the third party provider. For example, if a large number of impressions are expected to watch a video program, a higher price can be supported for the avail based upon the larger number of impressions expected. In contrast, if few viewers are expected for a video program, an avail would be less attractive to third party content providers. Moreover, the first avail in a video program is typically more attractive than subsequent avails in the same predefined break since more impressions are typically projected based on the lead-in from the video program.

Some models have proposed subsequently adjusting the amount paid for an avail based upon actual impression data. Such models reconcile the cost based on numbers of impressions as collected after a video program has aired. Other models have proposed using a price per conversion model whereby the provider of third party video content only pays for an avail based upon the actual effectiveness of the avail as measured by sales of the product or service from the avail. While these models provide increased efficiency for the third party purchaser, they provide little in the way of increased effectiveness of the third party commercial content itself or quality of the impression.

### SUMMARY

Systems, methods and computer-readable media for user directed third party video content are provided. Methods can include: providing a first segment of third party video content to a user device for display to the user; receiving a request from the user to skip the first segment of third party video content; retrieving a second segment of third party video content without further user input; and, providing the second segment of third party video content to the user device for display to the user.

Various systems can include a content server, an interface and a third party content manager. The content server can provide a first segment of third party video content to a user device for display to the user. The interface can receive a request from the user to skip the first segment of third party video content. The third party content manager can retrieve a second segment of third party video content from a third party content store without further user input beyond the request from the user to skip the first segment of third party video content. The third party content manager can then communicate the second segment of third party video content to the user device for display to the user.

Other systems, methods and computer-readable media should be apparent based upon the scope of the following disclosure and are intended to be included as part of this disclosure.

### BRIEF DESCRIPTION OF THE DRAWINGS

FIG. 1 is a block diagram illustrating an example network environment operable to provide user directed third party video content.

FIG. 2 is a block diagram illustrating an example system used to provide user directed third party video content.

FIG. 3 is a block diagram illustrating another example system used to provide user directed third party video content.

FIG. 4 is a flow diagram illustrating operation of user directed third party video content.

FIG. 5 is a flowchart illustrating an example process operable to provide user directed third party video content.

FIG. 6 is a flowchart illustrating another example process operable to provide user directed third party video content.

FIG. 7 is a block diagram of a third party content manager operable to provider user directed third party video content.

Like reference numbers and designations in the various drawings indicate like elements.

### DETAILED DESCRIPTION

In various implementations of this disclosure, systems and methods can operate to provide user directed customized content insertion. In some implementations, when video program encounters a commercial break, a user can select to skip a third party video content. In response to this selection, a content server, e.g., associated with the service provider, can record the user's selection to skip the third party content. In some implementations, the selection to skip the third party video content can be used to reconcile the amount paid for an avail by a third party content provider. In additional or alternative implementations, the selection to skip third party video content can be recorded and used to identify subjects of interest to the user or class of users or subjects that should be avoided with a particular user or class of users. For example, if the user consistently skips third party content offering automobiles, the video content server can avoid sending automobile-related third party content to the user.

In additional implementations, a decay function can be applied to a user's or class of users' preferences to avoid serving certain types of third party video content to the user or class of users. Thus, with reference to the previous example, the video content server can avoid sending car related advertisements to the user for a period of time, until the preference has expired or decayed to the point that it no longer prevents car-related video content from being served to the user.

In some implementations where a decay function is applied to the preference, the decay function can be varied based upon the type of content (e.g., product or service) represented by the third party video stream. Thus, for example, car-related advertisements can be assigned a longer decay function than an advertisement for ice cream. Thus, in this example, a preference against car-related advertisements would last longer than a preference against ice cream-related advertisements. In additional implementations, a consistent selection to skip a certain type or class of third party video content across a number reintroductions and/or product lines can lead to a longer decay function or even a permanent ban on third party video content involving the product or type of product.

Thus, in some implementations, the reception of requests to skip a segment third party video content can be used to infer user preferences, thereby creating a user profile or associating the user with a class of users. In other implementations, a user can directly provide information about him/herself to create the user profile or associate him/herself with a class of users. For example, the user can answer questions to a poll to identify the user's preferences. In still further implementations, a user's social profile can be used to infer preferences associated with the user. For example, information inferred or collected from a user's online associations (e.g., friends, groups, interests, etc.) collected from sites such as Facebook (available from Facebook, Inc. of Menlo Park, Calif.), Google+ (available from Google, Inc. of Mountain View, Calif.), or Twitter (available from Twitter, Inc. of San Francisco, Calif.), or other online social networking sites.

In response to skipping the third party video content, it should be recognized that a potential result of allowing the user to skip third party video content is the incentive for the user to skip all third party video content, thereby lowering the utility of an avail to a third party content provider. In some implementations, the request to skip a segment of third party video content can result in a blank screen (e.g., no programming) being presented to the user for the remaining duration of the current video slot selected for skipping, thereby reducing the incentive for the user to skip over avail for third party video content.

In other implementations, an video content server can select a new third party video content for serving to the user in response to the selection to skip the current third party video content. Additionally, the third party video content selected to be served can be selected based upon the time left in a current avail (e.g., previously assigned to the segment of third party video content that was skipped by the user). In some implementations, a category or type associated with the third party content selected to be skipped can be used to select a new segment of third party video content to be served to the user. In additional or alternative implementations, the advertisement served to the user after the selection to skip a segment of third party content can command a higher price because a content manager server records the selection to skip. The selection to skip can be used to infer that the user is paying attention to the third party video content, since he or she skipped the previous segment but did not skip the new replacement segment served by the third party content manager.

In some implementations, an interface (e.g., remote control) associated with a viewer of the third party video content can include a recommend button. In such implementations, a user interface can facilitate receiving instructions from user to refer to content to one or more other users (e.g., friends) or groups of other users.

In some implementations that allow a user to refer third party video content to one or more other users (e.g., including one or more groups of other users), the referral can cause the video content server to add the referred third party video content to a third party video content queue associated with the one or more users who have been referred the third party video content.

In some implementations, a user can be incentivized to refer third party video content to one or more other users. In such implementations, a rewards program can be used to encourage users to refer video content to other users. The rewards program can include, for example, award points which can be used to purchase games or other content. In some implementations, when a referrer refers the third party content to other users, one or more of whom then makes a purchase of the product, the points awarded to the viewer can be greater than the points awarded when the other users do not make a purchase of the product.

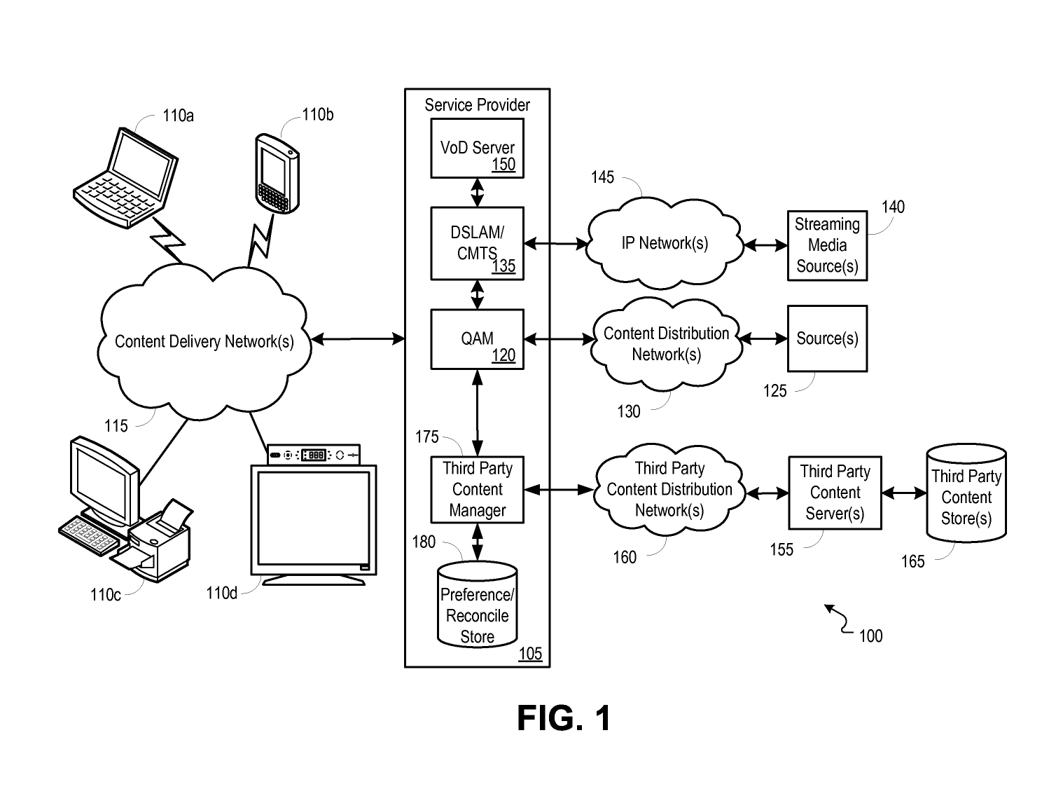

FIG. 1 is a block diagram illustrating an example network environment 100 operable to provide user directed customized adjustable content insertion. The network environment 100 can include a service provider 105. It should be understood that the service provider 105 can be a wireless base station, a DSL central station, a hybrid FiOS central office, among many others. The service provider 105 can operate to provide services to subscribers 110a-d, including, for example, video services. These services can be provided using a content delivery network 115. One example of a content delivery network 115 includes a hybrid fiber coax (HFC) network. Other examples of content delivery networks 115 can include, among many others, digital subscriber line (xDSL) networks, wireless networks, or the Internet, and combinations thereof.

In some implementations, the video services can be transmitted over the content delivery network 115 by a quadrature amplitude modulation (QAM) device 120. In other implementations, the video services can be transmitted over the content delivery network 115 by a DSL access multiplexer (DSLAM) device, an Internet router, or another network edge device.

In some implementations, content can be provided to the QAM device 120 from a content source 125. The content source 125 can deliver the content to the QAM device 120 over a content distribution network 130. Content distribution networks can include private networks and/or virtual private networks set up to distribute content to the service provider 105.

In additional and/or alternative implementations, the QAM device 120 can also receive content from a digital subscriber line access multiplexer (DSLAM)/cable modem termination system (CMTS) 135. The DSLAM/CMTS 135 can typically receive content from one or more streaming media sources 140 via, for example, an IP network 145. The IP network 145, for example, can include the Internet. The DSLAM/CMTS 135 can perform functions similar to a network router and receive packetized video data and provide the packetized video data in unicast, multicast or broadcast formats to one or more recipient devices.

The QAM device 120 can also receive video content from a video on demand (VoD) server 150. The VoD server 150 can operate to store video content for on demand retrieval and playback for subscribers. While the VoD server 150 is shown connected to the DSLAM/CMTS 135, the VoD server 150 can be coupled directly to the QAM device 120. The VoD server 150 can receive requests for video content and provide the requested video content to the requesting subscriber(s).

The QAM device 120 can also receive content from one or more third party content servers 155, such as, for example, a video advertisement server over a third party content distribution network 160. The third party content server 155 can provide third party video content for insertion into the original content provided by a streaming media source 140, a content source 125 or a VoD server 150 (or any other video source). In some implementations, the content provided by the streaming media source 140, the content source 125, or the VoD server 150 can be tagged or marked to identify advertisement slots or third party content avails within the program stream. In some implementations, the source 125, 140, 150 providing the content can notify the service provider 105 in advance of the slot of the length of the avail for insertion of third party content. The service provider 105 can communicate this information to the third party content server 155 to retrieve third party content segments of the correct duration. In some implementations the third party content server 155 can adjust a served segment to fit the duration of the third party video content avail(s), e.g., by speeding up or slowing down the video slightly, or cutting the segment to the correct duration. Third party content can include metadata identifying the amounts by which the segment can be cut at the beginning and/or the end to change the duration of the third party video content.

In additional implementations, the source 125, 140, 150 can notify the service provider of a demographic associated with the program stream. For example, if the program stream were sports related, the source can identify a specific demographic associated with the content, such as men ages 18-34 interested in sports. In such implementations, the service provider 105 can communicate the demographic information to the third party video content server 155, which can use the information to select an appropriate third party video content segment. In the above example, the third party content server 155 might select a sporting goods advertisement or a beer advertisement for inclusion in the third party content slot.

In various implementations, the third party content server 155 can be part of the content source. Thus, the content source 125, 140, 150 can select the segment for inclusion within the content and tag the third party video content included within the content to facilitate skipping and/or replacing an originally included segment. In some implementations, the original third party segments or metadata describing the third party video content segments can be sent to the service provider 105 in advance of the airing of the program stream. In such implementations, the service provider 105 can determine whether a subscriber 110a-d has a preference against third party video content of the type included one or more of the slots, and communicate with an third party content server 155 to replace the third party video content segment before the video content is served to the subscriber 110a-d.

In some implementations, third party video content communicated to the service provider 105 in advance of the airing of the program stream can be transmitted to a subscriber device 110a-d in advance of the airing of the program. Such third party video content can be cached locally by the device until air time. Additionally, it should be appreciated that in some implementations, alternative or replacement third party video content can be pre-cached locally at the subscriber device 110a-d to reduce latency in providing replacement third party video content when a user has selected to skip and/or replace the original third party video content. In such implementations, the pre-cached third party video content can include alternative third party video content for each original segment of third party video content scheduled to air during the third party video content break. In those instances where the user selects to skip or replace an original segment third party video content, the subscriber device can thereby immediately replace the original segment of third party video content with the pre-cached alternative third party video content. In some implementations, upon replacement of the original third party video content, the subscriber device can communicate the replacement of the original third party video content to the third party video content server 155 and facilitate retrieval of a second alternative segment of third party video content, in case the user selects to skip the first alternative segment of third party video content.

In some implementations, the service provider 105 can further include a third party content manager 175 operable to manage the retrieval of replacement third party content from user devices. The third party content manager 175 can be operable to record instances of the user deciding to skip third party video content in a preference/reconcile data store 180. The instance of the user skipping third party video content can be used to reconcile an account associated with a third party content provider (e.g., an advertiser). Thus, in some implementations, the third party content provider can be charged a reduced rate for an avail that the user does not view fully.

In some implementations, an instance of a user deciding to skip a third party video content segment can be recorded in the preference database 180. Thus, the user's preferences can be inferred from the third party video content the user decides to skip. The third party video content manager 175 can then use the preferences to determine which third party video content to fetch and serve to the user during a break in the primary content. In additional or alternative implementations, the user can provide preference information directly by responding to a poll or survey. Alternatively, preference information can be inferred from preference profile information associated with a social network to which the user belongs. In still further alternatives, groups of users with similar selections to skip third party content can be used to infer the preferences of other users in the same group.

In some implementations, the third party content manager 175 can receive other types of feedback from the user. For example, the user might recommend a piece of third party video content to a friend or group of friends. In such examples, the third party content manager 175 can queue up the recommended third party video content for the friend or group of friends. Thus, the recommended content can be served during a next break in the video content.

The third party content manager 175 can use the referral to infer that the third party video content has been actively viewed (e.g., viewed with interest) by a user and can charge the third party a larger share for the impression than would normally be charged to a user. The third party content manager 175 can use the preference/reconciliation data store to identify the referral and the additional charge to the third party for the impression based upon the additional value the third party received from the impression. In some implementations, the third party video content can be interactive, thereby facilitating commercial transactions during the presentation of the third party video content (e.g., a conversion). In such implementations, the third party content manager can charge a third party a higher rate for the impression based upon the conversion.

In some implementations, the third party content manager 175 can implement a rewards system operable to incentivize users to refer third party content to other users. The rewards system, for example, can include points redeemable for video content, graphic content, music content, applications, and/or video games. In those implementations including interactive third party content segment, additional points can be rewarded to users who refers other user that result in a conversion for a third party as a result of the referral of the third party video content.

It should be understood that in some examples, users may not wish to receive referrals of third party video content from other users (e.g., friends). In such instances, some implementations can facilitate such users entering preferences against third party video content referrals. Thereby disallowing the user's friends from referring third party video content to them. Alternatively, the user can be allowed to set preferences against referrals from a specified first set of other users, or allowing referrals from a specified second set of other users.

In some implementations, the video programming provided by the sources 125, streaming media sources 140 or VoD server 150 can include parameters for overlaying advertisements within the content. The video stream can include metadata that provides boundaries for inclusion of third party content within the video stream. Thus, the third party content manager can add third party content outside of the periods of time during which the entirety of the content can be replaced. For example, if an actor during a scene were drinking a soda, the video program metadata might outline the boundaries of the soda can and identify the type of product, and allow the third party content manager to overlay a different brand of soda over the original soda can. Alternatively, a billboard in a scene may be interactive, allowing the third party content manager to overlay specialized content tailored to the user's likes or dislikes. In some implementations, the user can provide input regarding preferences for the types of third party content to replace, the types of content he/she prefers, etc. Such input can be provided directly through the use of polls or surveys, or inferred from input received from the user or from association with a particular social network.

While the IP network(s) 145, content distribution network(s) 130, and third party video content delivery networks 160 are shown as separate networks, in various implementations, any one or more of the networks can use the same physical network as another one or more of the networks. Additionally, in some implementations, the content delivery network can be part of any of the aforementioned networks, or combinations thereof.

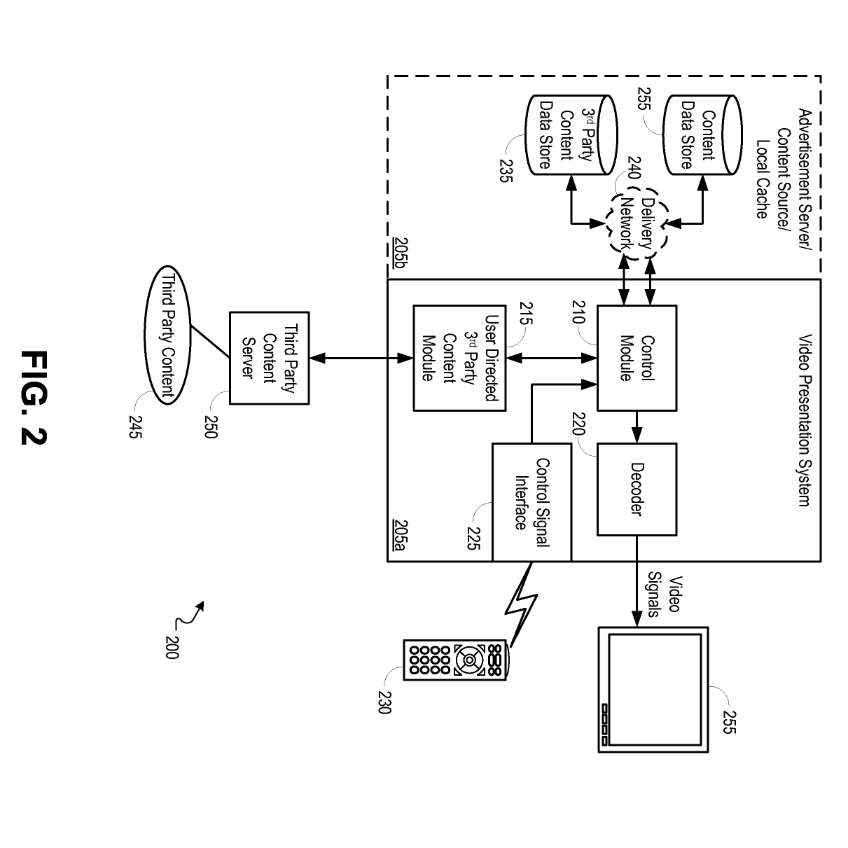

FIG. 2 is a block diagram illustrating an example system 200 used to provide user directed third party content. A video presentation system 205a can include a control module 210, a user directed third party content module 215, a decoder 220 and a control signal interface 225. In some implementations, the control module 210 can be a processor or controller operable to execute computer readable machine code. The computer readable machine code can operate to instruct the control module 210 what functions to perform.

In some implementations, the user directed third party content module 215 can be computer readable machine code operable to be executed by the control module 210. The user directed third party content module 215 can instruct the control module 210 to skip over a segment of third party video content being rendered by the decoder 220. When an instruction to skip a segment of third party video content is received, the user directed third party content module 215 can direct the control module 210 to retrieve one or more replacement segments of third party video content from an third party video content data store 235 via a content delivery network 240. In some implementations, the user directed third party content module 215 can be programmed to retrieve one or more replacement third-party content segments 245 from a third party content server 250.

An instruction to skip a segment of third party video content can be received from a control device 230 through the control signal interface 225. In various implementations, the control signal interface 225 can be any one or more of an infrared sensor, a radio frequency sensor (e.g., 802.11x, Bluetooth, etc.), an integrated device interface, or any combination thereof. In those implementations that include only an integrated device interface, the control device 230 can be eliminated. In some implementations, the control device can be a mobile phone or other device acting as a remote control. In other implementations, the control device can be a gesture recognition system that allows users to skip ads with a combination of hand gestures to a motion detection system. In still further implementations, the control device can receive audio input to skip ads.

In various implementations, content received from a content data store 255 via a content delivery network 240 can be processed by the video presentation system 205a. The content received at the video presentation system 205a can be processed by the decoder 220 and rendered for output to a display device 255. In various implementations, the content provided by the content delivery network 240 can be provided in any of a variety of formats, for example, including MPEG-2, MPEG-4-H.26×, advanced video coding (AVC), etc. In some implementations, the display device 255 can be an external display device, an integrated display device, or any combination thereof.

In various implementations, the content data store 255 can be located remotely from the video presentation system 205a or locally to the video presentation system 205a. For example, the content data store 255 can be located at a content source (e.g., source 125 of FIG. 1), or can be co-located with the video presentation system 205a. It should also be appreciated that in various implementations, the third party content data store 235 can be located remotely from the video presentation system 205a or locally to the video presentation system 205a. For example, the third party video content data store can be located at a third party video content server (e.g., third party video content server 155 of FIG. 1), or can be co-located with the video presentation system 205a.

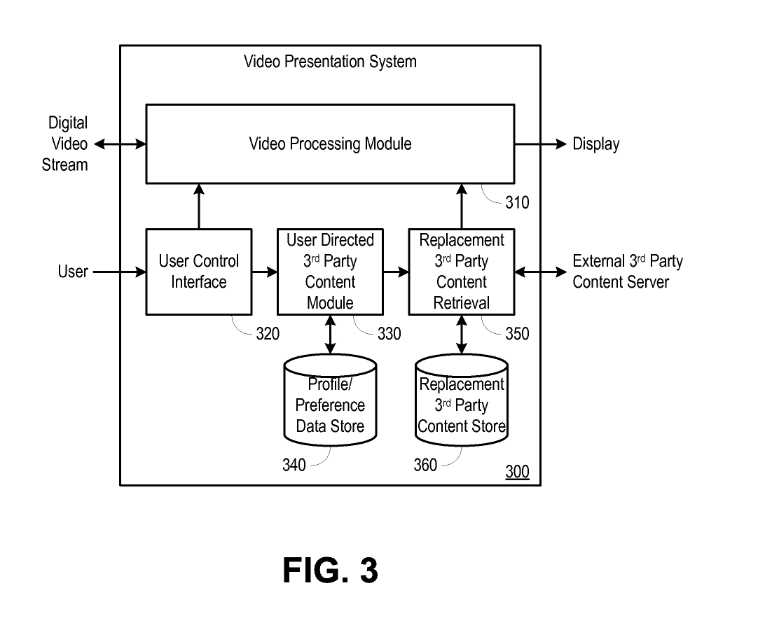

FIG. 3 is a functional block diagram illustrating another example video presentation system 300 used to provide user directed third party video content. The video presentation system 300 can include a video processing module 310, a user control interface 320, a user directed third party video content module 330 and profile data store 340, and a replacement third party content module 350 and replacement third party content data store 360.

The video presentation system 300 can receive a digital video stream at a video processing module 310. In some implementations, the video processing module 310 can operate to receive and decode the digital video signal and provide the video signal to a display device. In various implementations, the display device can be internal or external to the video presentation system 300. The incoming digital video can be received in any of a variety of digital video formats, including both standard definition and high definition formats.

In some implementations, the digital video can include tags. The tags can mark, for example, the edges of third party content break and/or program content surrounding third party content breaks. These tags can be used to identify, for example, boundaries for replacement third party video content. Replacement third party video content such as, e.g., advertisements can be provided to replace another segment of third party video content when a user requests to skip a segment of third party video content.

In other implementations, the digital video does not include tags. In such implementations, third party video content can be inferred by a request from a user to skip the third party video content. In such implementations, the replacement third party video content module 350 can retrieve a replacement segment of third party video content from a local replacement third party video content data store 360 or from a remote replacement third party video content server (e.g., third party video content server 155 of FIG. 1). In these implementations, the replacement video content can be chosen to be sufficiently small enough so as to not run into a following segment of third party video content or the program content following the third party video content break.

In some implementations, the user control interface 320 can operate to receive input from a user of the video presentation system 300. The input can include channel change requests, volume change requests, and/or requests for electronic/interactive program guides, as well as a request to skip or replace a current segment of third party video content. Channel change requests can be communicated upstream to a service provider, in some implementations, by the video processing module 310. Other modules can be used to communicate channel change requests upstream. Likewise, in some implementations, requests for a electronic/interactive program guide can be communicated to the video processing module 310, which can include an electronic/interactive program guide generation module (not shown) to generate and render an electronic/interactive program guide for display by a display device. In some implementations, the channel change requests can be transmitted via a mobile phone or other device acting as a remote control. In other implementations, the channel change requests can be a gesture recognition system that allows users to skip ads with a combination of hand gestures to a motion detection system. In still further implementations, the channel change requests can receive audio input to skip ads.

In some implementations, user requests to skip or replace a segment of third party video content can be provided to both the video processing module 310 (or an upstream feedback module) and a user directed third party video content module 330. The video processing module (or an upstream feedback module) can provide information about the user input and timing (e.g., program clock reference (PCR)) to a service provider. Further, in some implementations, the video processing module can be instructed to stop rendering the current segment of third party video content.

The user directed third party video content module 330 can record the user input in a profile data store 340 as feedback to the segment of third party content currently being displayed. In some implementations, this feedback can be used to select a replacement segment of third party video content to display to the user. Thus, the feedback can be used to identify that a user does not like a certain type of third party video content (e.g., car advertisements) or brand (e.g., University of Phoenix). In some implementations, these preferences can have a decay function applied to the preference such that immediately after a preference is indicated, that type of content is less likely to be shown, and after a long period of time, that type of content becomes equally likely to be shown as other content. In further implementations, the preferences can be implemented on a periodic scale. For example, if a user indicates a preference against iPhone advertisements, the preference can be removed after a new generation of iPhone is released or after an average life cycle period for that product.

The profile or preference information can be forwarded to the replacement third party content retrieval module 350. In some implementations, the replacement third party content retrieval module 350 can use the profile/preference information associated with a user to identify a replacement segment of third party content for the video presentation system 300. In various implementations, the replacement thid party content retrieval module 350 can retrieve replacement segments from a local replacement third party content data store 360 or from an external third party video content server (e.g., third party video content server 155 of FIG. 1).

In some implementations, a replacement segment of third party content can also be selected based upon a time left for a current avail. For example, if the user was five seconds into a 30 second avail, the replacement segment of third party content can be specified to be 22-25 seconds. In some implementations, a third party content segment that does not fill the entire remainder of the slot can be extended (e.g., by slowing down the video and audio) by an amount that would close the gap between the replacement content and the remaining time left in the avail. Similarly, a replacement segment of third party content that is slightly too long can be sped up in order to fit within the remaining time left in the avail.

Upon retrieval of a replacement third party content segment, the replacement third party content retrieval module 350 can be forwarded to the video processing module 310. In turn the video processing module can replace the current stream with the replacement segment of third party content received from the replacement third party content retrieval module 350.

In some implementations, the video processing module 310 can also provide feedback to the service provider (e.g., service provider 105 of FIG. 1). The feedback received from the video presentation system 300 at the service provider can be used to adjust an third party's payment for an avail. Thus, the service provider can determine that an impression for the third party content that was skipped is worth less than an impression for a segment of third party content that was viewed in full by a user. Additionally, the information about the replacement third party content segment can be used to charge the third party content provider represented by the replacement segment of third party content. In some implementations, the third party provider represented by the replacement segment can be charged a premium for the replacement segment because of the nature of the impression. For example, when a user has skipped an segment, it can be assumed that a user is not only watching the display, but is actively watching the display and paying attention to the segment (since he/she skipped an original segment of third party video content but did not skip a replacement segment). Moreover, because the user profile/preference information is used to identify a replacement segment of third party content, the replacement segment becomes better targeted to the user and is therefore worth more to the third party provider.

In other implementations, a marketplace for the replacement segments of third party content can be provided. Thus, third party providers can outline specifications for bidding on replacement avails before they become available. Automated auctions can then take place to determine which of any number of suitable replacement segments are provided to the video presentation system 300. This auction would provide a market price for the replacement segments of third party video content based upon specific target parameters identified by the third party.

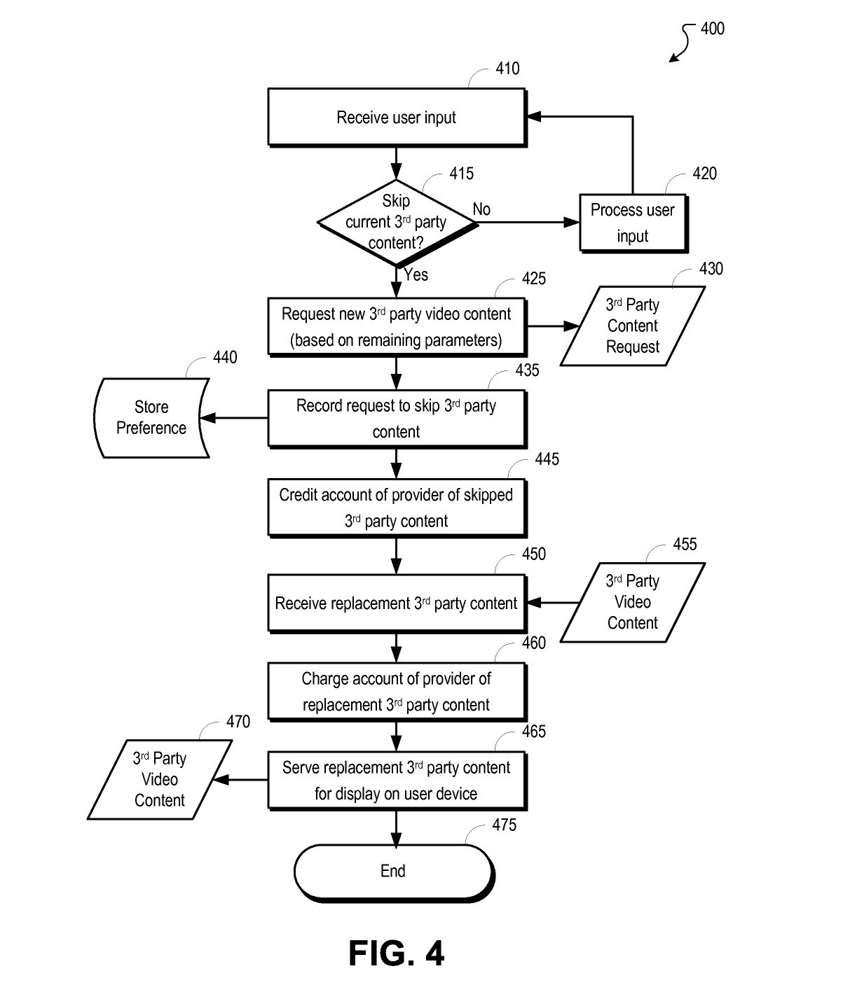

FIG. 4 is a flow diagram illustrating a process 400 for user directed third party video content. At stage 410, user input is received. The user input can be received, for example, at a third party content manager (e.g., third party content manager 175 of FIG. 1), a third party content server (e.g., third party content server 155 of FIG. 1), or a video presentation system (e.g., video presentation system 205a of FIG. 2). The user input can be received via a set top box.

At stage 415, a determination is made whether the user input is a request to skip the current third party content. The determination can be made, for example, by a third party content manager (e.g., third party content manager 175 of FIG. 1; user directed third party content module 215 of FIG. 2; or, user directed third party content module 330 of FIG. 3). If the input is not a request to skip the third party content, the process 400 proceeds to stage 420, where the user input is processed. The user input can be processed, for example, by a processor (e.g., control module 210 of FIG. 2 or video processing module 310 of FIG. 3).

At stage 425, new third party video content is requested. The new third party video content is requested, for example, by a third party content manager (e.g., third party content manager 175 of FIG. 1, user directed third party content module 215 of FIG. 2 or replacement third party content retrieval 350 of FIG. 3). The third party video content can be requested from a replacement third party content data store in conjunction with user preference data retrieved from the profile/preference data store by the user directed third party content module. In some implementations, the third party video content request 430 can include parameters which can be used to select third party content to fill the avail.

At stage 435, the request to skip third party content can be recorded. The request can be recorded, for example, by a third party content server (e.g., third party content server 155 of FIG. 1 or third party content server 250 of FIG. 2). In some implementations, recording the request to skip the third party content can include storing preference information 440 in a preference/reconcile data store (e.g., preference/reconcile data store 180 of FIG. 1).

At stage 445, the account of a provider of the skipped third party content can be credited. The account can be credited, for example, by a third party content manager (e.g., third party content manager 175 of FIG. 1) in conjunction with a preference/reconcile data store (e.g., preference/reconcile data store 180 of FIG. 1). In some implementations, the account can be credited to reduce the amount charged to the provider of the third party video content based upon the user skipping the third party content.

At stage 450, replacement third party video content 455 is received. The replacement third party video content 455 can be received, for example, by a third party content manager (e.g., third party content manager 175 of FIG. 1, user directed third party content module 215 of FIG. 2, or replacement third party content retrieval 350 of FIG. 3).

At stage 460, an account associated with a provider of the replacement third party content is debited. The account can be debited, for example, by a third party content manager (e.g., third party content manager 175 of FIG. 1) and/or third party content servers (e.g., third party content server 155 of FIG. 1). In some implementations, the account associated with the replacement third party video content can be charged a premium based on the presumption that because the user requested to skip the previous third party video content, the user is paying attention to the third party video content.

At stage 465, replacement third party content 470 for display on user device is served. The replacement third party content 470 can be served, for example, by a third party content manager (e.g., third party content manager 175 of FIG. 1). The process 400 ends at stage 475.

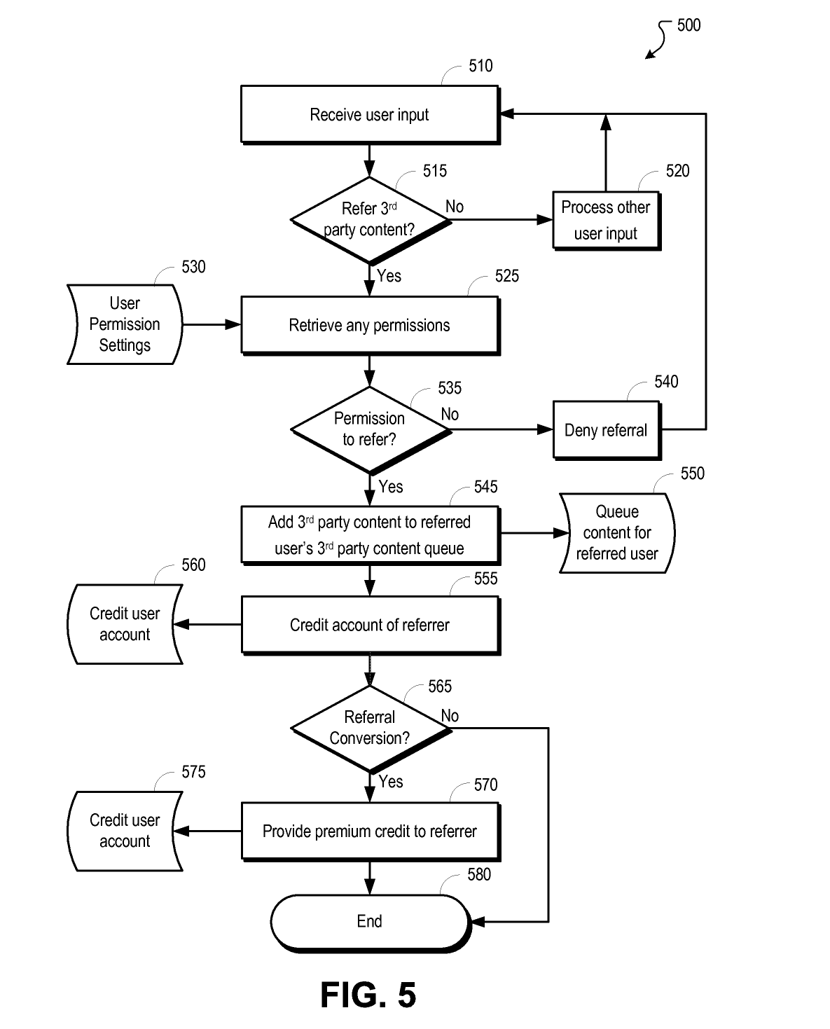

FIG. 5 is a flowchart illustrating an example process 500 operable to provide user directed third party video content. The process begins at stage 510, where user input is received. The user input can be received, for example, at a third party content manager (e.g., third party content manager 175 of FIG. 1), a third party content server (e.g., third party content server 155 of FIG. 1), or a video presentation system (e.g., video presentation system 205a of FIG. 2). In some implementations, the user input can be received via a set top box.

At stage 515, a determination is made whether the user input is requesting to refer third party video content to another user. The determination that a user is requesting to refer third party video content can be made, for example, by a third party content manager (e.g., third party content manager 175 of FIG. 1). In some implementations, the referral can be made via a specialized “share” button on a remote control associated with a set top box or display device. The request to refer third party video can include identification of the other user or group of users to which the third party video content is being referred. If the user input is not requesting to refer third party video content, at stage 520, the process 500 processes the other user input. The user input can be processed, for example, by a processor (e.g., control module 210 of FIG. 2 or video processing module 310 of FIG. 3).

However, if the user input is requesting referral of the third party video content, the process continues to stage 525, where user permissions/settings 530 are retrieved. The user permissions/settings 530 can be retrieved, for example, by a third party video content manager (e.g., third party content manager 175 of FIG. 1) in conjunction with a user preference data store (e.g., user preference/reconcile data store 180 of FIG. 1). The user permissions/settings 530 can allow a user to block referrals from other users, or block referrals from certain other users, or only allow referrals from a specified set of other users. In some implementations, the permissions/settings 530 can specify only certain types of third party video content be referred, or exclude certain classes of third party video content from referral (e.g., based upon the content or a rating associated with the third party video content). In some implementations, the permission to refer the third party video content can also be based on permissions of the provider of the third party video content to refer the content to other users. For example, a provider may target a certain class of user or be unwilling to pay for a referral. In such examples, the provider can specify preferences against referral or preferences for referral to only certain types of users.

At stage 535, a determination of whether the user has permission to refer is made. The determination can be made, for example, by a third party video content manager (e.g., third party content manager 175 of FIG. 1). If the user does not have permission to refer the third party content, the process proceeds to stage 540 where the referral is denied. The referral can be denied, for example, by a third party video content manager (e.g., third party content manager 175 of FIG. 1).

However, if the user does have permission to refer the third party video content, the process proceeds to stage 545 where the third party video content is added to a queue associated with the referred user(s). The third party video content can be added to the referred party's queue, for example, by a third party content video manager (e.g., third party content manager 175 of FIG. 1) in conjunction with a video server (e.g., third party video content server 155 of FIG. 1). In some implementations, an instruction 550 to add the content to the referred user's queue can be sent to a third party video server or to the user's preference/profile (e.g., preference/profile data store 180 of FIG. 1).

At stage 555, an account associated with the referring party can be credited. The account can be credited, for example, by a third party video content manager (e.g., third party content manager 175 of FIG. 1) sending a credit instruction 560 to an account data store (e.g., user preference/reconcile data store 180 of FIG. 1). In some implementations, the account being credited can be a rewards program account. In such implementations, the rewards program can provide incentives for the user to refer content to other users. Incentives can include small games, video clips, sweepstakes, or other content desirable to users. In other implementations, the referring user's account with the service provider can be credited, thereby reducing his/her subscription fees for the service provider's services (e.g., his/her subscription fees can be discounted). In still further implementations, the credit can be a record that the commercial was viewed and/or the duration that the user viewed the commercial (e.g., a partial viewing of the commercial prior to another user direction).

At stage 565, a determination is made whether a conversion is made on the referral. The determination of whether a conversion takes place can be made, for example, by a third party video content manager (e.g., third party video content manager 175 of FIG. 1). In some implementations, the conversion can be the referred user consuming the third party video content. In other implementations, a conversion can be the referred party actually executing a transaction based on the third party video content. In such implementations, the third party video content would be interactive video content, enabling the user to interact with a server to execute a transaction with the provider of the third party video content as a result of viewing the third party video content. If no conversion is made, the process 500 ends at stage 580.

If a conversion is made, the process 500 continues to stage 570 where a premium credit is made to an account associated with the referring user. The premium credit can be applied, for example, by a third party video content manager (e.g., third party content manager 175 of FIG. 1) sending an instruction 575 to credit the referring user's account to an account data store (e.g., preference/reconcile data store 180 of FIG. 1). The premium credit can be applied to further incentivize the user to refer third party video content to other users. Additionally, the premium credit can incentivize the party to refer the third party content to other users that the referring user knows is interested in a product or service associated with or represented by the provider of the third party video content. The process then ends at stage 580.

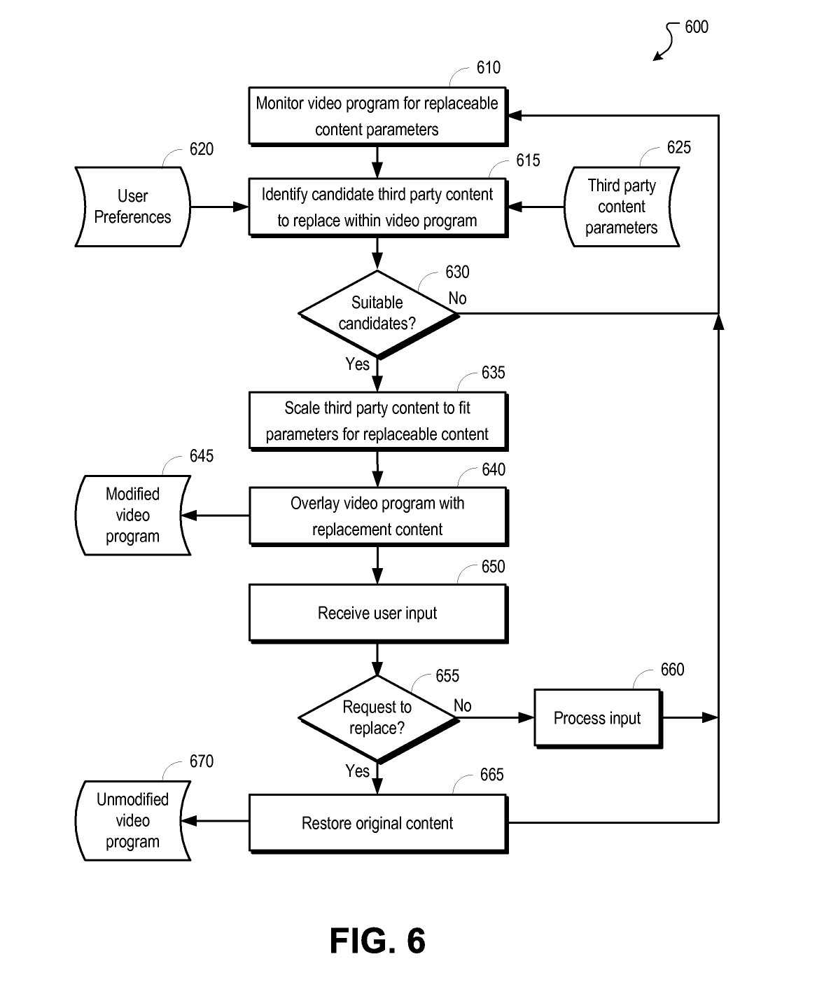

FIG. 6 is a flowchart illustrating another example process 600 operable to provide user directed third party video content. At stage 610, an incoming video program is monitored for replaceable content parameters. The incoming video program can be monitored for replaceable content parameters, for example, by a third party content manager (e.g., third party content manager 175 of FIG. 1). The incoming video program can be programming provided by a network or some other source. In some implementations, components of the incoming video program can be marked as replaceable. For example, an actor within the video program may be drinking from a soda can. The video program can identify the soda can as replaceable and provide parameters for replacing the soda can within the frame (e.g., the boundaries of the soda can). In another example, there may be a billboard shown in a frame (or multiple frames) of a video program. The video program can identify the billboard as replaceable and outline the parameters for replacing the original content of the billboard (e.g., pixel locations of the boundaries of the billboard, acceptable content, dark/light levels, a layer in which the billboard resides in the frame, etc.).

At stage 615, candidate third party content to replace original content from the video program is identified. The candidate third party content can be identified, for example, by a third party content manager (e.g., third party content manager 175 of FIG. 1) with user preference input 620 received from a preference data store (e.g., preference/reconciled data store 180 of FIG. 1) and/or third party content parameter input 625 retrieved from third party content servers (e.g., third party content server 155 of FIG. 1). In some implementations, the user preference information can be inferred from user activity (e.g., skipping advertisements or rejecting replacement content), and stored to the preference data store. In additional or alternative implementations, user preference information can be gathered directly from the user. For example, the user can be provided a survey whereby the user states preferences including, for example, among others, products, services, video content, genres, categories, etc., which can be used to identify content of interest to the user.

At stage 630, a determination is made whether suitable replacement candidates have been identified. The determination can be made, for example, by a third party content manager (e.g., third party content manager 175 of FIG. 1). In some implementations, the mere existence of candidate replacement content can be used to infer that a suitable replacement candidate is identified. In other implementations, the system can further analyze the candidate replacement content to ensure that the content is suitable based upon user preferences and video quality levels.

At stage 635, the third party content is scaled to fit within the boundary parameters identified by the video program. The third party content can be scaled, for example, by a video processor associated with a third party content manager (e.g., third party content manager 175 of FIG. 1). Scaling can include reducing or increasing the size of an object for replacing the original content and can be based upon boundary parameters associated with the content. Scaling can also include lightening or darkening the replacement content based upon the lightness or darkness of the frame of the original video program, such that the replacement content does not materially alter the feel of a scene. In some implementations, the size, lightness/darkness of the frame, angle of the content to be replaced, and other relevant parameters can be included in metadata provided to the third party content manager with the video program.

At stage 640, the video program is overlayed with the scaled replacement content. The video program can be overlayed with the scaled replacement content, for example, by a video processor associated with a third party content manager (e.g., third party content manager 175 of FIG. 1). The overlayed frame can be used to produce a modified video program 645 for communication to a set top box or display device.

At stage 650, user input is received. User input can be received, for example, by a third party content manager (e.g., third party content manager 175 of FIG. 1) via graphical user interface, e.g., originated from a set top box (e.g., video presentation system 205a) or other customer premise equipment (CPE) device.

At stage 655, a determination is made whether the input is a request to replace the overlayed content. The determination can be made, for example, by a third party content manager (e.g., third party content manager 175 of FIG. 1). If the input is not a request to replace, the user input is processed at stage 660. The user input can be processed, for example, by a video presentation system (e.g., video presentation system 205a of FIG. 2 or video presentation system 300 of FIG. 3), or a third party content manager (e.g., third party content manager 175 of FIG. 1).

If the input is a request to replace the overlayed content, at stage 665 the original content is restored. The original content can be restored, for example, by a third party content manager (e.g., third party content manager 175 of FIG. 1) or by a video presentation system (e.g., video presentation system 205a of FIG. 2 or video presentation system 300 of FIG. 3). In some implementations, the overlayed content merely covers over the original content, but the original content remains in the transmission, such that a CPE device can remove the overlay itself to reveal the original content. In other implementations, the third party content manager can discontinue its modification of the video program thereby producing an unmodified video program 670. The process 600 then continues by monitoring the incoming video content for additional replacement opportunities.

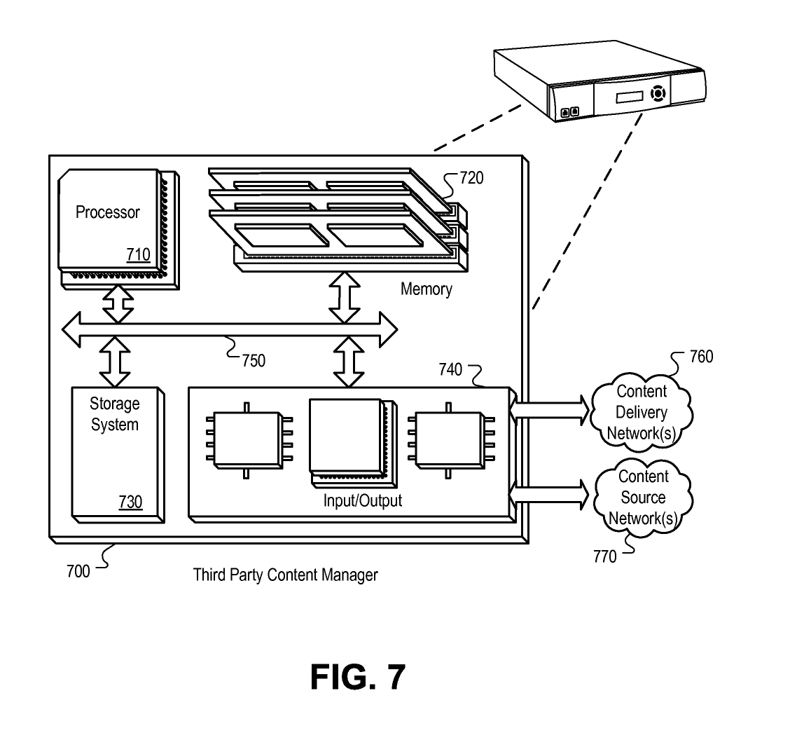

FIG. 7 is a block diagram of an example third party content manager 700 operable to provide user directed third party video content. The third party content manager 700 can include a processor 710, a memory 720, a storage device 730, and an input/output device 740. Each of the components 710, 720, 730, and 740 can, for example, be interconnected using a system bus 750. The processor 710 is capable of processing instructions for execution within the ad server 700. In one implementation, the processor 710 is a single-threaded processor. In another implementation, the processor 710 is a multi-threaded processor. The processor 710 is capable of processing instructions stored in the memory 720 or on the storage device 730.

The memory 720 stores information within the device 700. In one implementation, the memory 720 is a computer-readable medium. In one implementation, the memory 720 is a volatile memory unit. In another implementation, the memory 720 is a non-volatile memory unit.

In some implementations, the storage device 730 is capable of providing mass storage for the ad server 700. In one implementation, the storage device 730 is a computer-readable medium. In various different implementations, the storage device 730 can, for example, include a hard disk device, an optical disk device, flash memory or some other large capacity storage device.

The input/output device 740 provides input/output operations for the ad server 700. In one implementation, the input/output device 740 can include one or more of a plain old telephone interface (e.g., an RJ11 connector), a network interface device, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, such as one or more subscriber devices 760 (e.g., set top box, cable modem, etc.), as well as sending communications to, and receiving communications from a network 770. Other implementations, however, can also be used, such as mobile computing devices, mobile communication devices, set-top box television client devices, etc.

The user directed third party video content described in this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

The term “system processor” encompasses all apparatus, devices, and machines for processing data, including by way of example a programmable processor, a computer, or multiple processors or computers. The system processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The elements of a computer typically include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile communications device, a telephone, a cable modem, a set-top box, a mobile audio or video player, or a game console, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be operable to interface with a computing device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

What is claimed is:

1. One or more computer readable media operable to execute on a processor, the computer readable being operable to cause the processor to perform operations comprising:
receiving video programming comprising a content stream having one or more available insertion profiles for the insertion of one or more segments of third party content;
selecting a first segment of third party video content for inclusion in the video programming, the selection of the first segment of third party video content being based upon a user profile associated with a user to whom the video programming is being provided and based upon timing associated with the insertion profiles;
inserting the first segment of third party video content into the video programming responsive to the one or more available insertion profiles;
providing the video programming including the first segment of third party video content to a user device associated with the user, wherein the user device is operable to display the video programming to the user;
receiving a request from the user to skip the first segment of third party video content included within the video programming provided to the user device;
selecting a second segment of third party video content for inclusion in the video programming without further user input, the selection of the second segment of third party video content being based upon a user profile associated with the user, the request to skip the first segment of third party video content, a profile of the video programming and one or more remaining insertion profile; and
providing the video programming including the second segment of third party video content to the user device, wherein the user device is operable to display the video programming to the user.

2. The one or more computer readable media of claim 1, further operable to cause the processor to perform operations comprising:
receiving a request to refer a segment of third party content to a set of one or more additional users; and
adding the referred third party content to a third party content queue associated with the second user.

3. A computer-implemented method, comprising:
providing a first segment of third party video content to a user device for display to the user;
receiving a request from the user to skip the first segment of third party video content;
retrieving a second segment of third party video content without further user input in addition to the request from the user to skip the first segment of third party video content; and
providing the second segment of third party video content to the user device for display to the user.

4. The computer-implemented method of claim 3, further comprising:
retrieving profile information associated with the user from a profile data store; and
selecting the second segment of third party video content based upon the user profile information retrieved from the profile data store.

5. The computer-implemented method of claim 4, further comprising:
recording the request to skip the first segment of third party video content as a preference associated with the user, wherein the preference is stored to the profile data store.

6. The computer-implemented method of claim 4, wherein selecting the second segment of third party video content is further based upon a profile associated with a slot made available by the request to skip the first segment of third party video content.

7. The computer-implemented method of claim 3, wherein a first provider associated with the first segment of third party video content and a second provider associated with the second segment of third party video content are different providers.

8. The computer-implemented method of claim 6, further comprising:
crediting a first account associated with the first provider responsive to the user requesting to skip the first segment of third party video content; and
debiting a second account associated with the second provider responsive to providing the second segment of third party video content to the user device.

9. The computer-implemented method of claim 8, wherein the credit is operable to reduce the amount the first provider paid to provide the first segment of video content to the user device.

10. The computer-implemented method of claim 9, wherein a premium is applied to the debit against the second account responsive to the inference that a user is actively viewing a video stream provided to the user device.

11. The computer-implemented method of claim 8, wherein an amount debited from the second account is based upon a bid associated with the second segment of third party video content.

12. The computer-implemented method of claim 3, wherein the first segment of third party video content and second segment of third party video content comprise advertisements.

13. The computer-implemented method of claim 3, further comprising:
receiving a request to refer third party content comprising the first segment or second segment of third party content to a second user; and
adding the referred third party content to a third party content queue associated with the second user.

14. The computer-implemented method of claim 13, further comprising:
determining whether the user has permission to refer the third party content to the second user;
wherein adding the referred third party content to the third party content queue is performed responsive to determining whether the user has permission to refer the third party content to the second user.

15. A system, comprising:
a content server operable to provide a first segment of third party video content to a user device for display to the user;
an interface operable to receive a request from the user to skip the first segment of third party video content;
a third party content manager operable to retrieve a second segment of third party video content from a third party content store without further user input beyond the request from the user to skip the first segment of third party video content, wherein the third party content manager is further operable to communicate the second segment of third party video content to the user device for display to the user.

16. The system of claim 15, wherein the third party content manager is further operable to retrieving profile information associated with the user from a profile data store, and to select the second segment of third party video content based upon the user profile information retrieved from the profile data store and based upon a profile associated with a slot made available by the request to skip the first segment of third party video content.

17. The system of claim 16, wherein the third party content manager is further operable to record the request to skip the first segment of third party video content as a preference associated with the user, wherein the preference is stored to the profile data store.

18. The system of claim 15, wherein the a third party content manager is operable to credit a first account associated with a first provider of the first segment of third party video content in response to the user requesting to skip the first segment of third party video content, and is further operable to debit a second account associated with a second provider of the second segment of third party video content in response to communicating the second segment of third party video content to the user device.

19. The system of claim 18, wherein an amount debited from the second account is based upon a bid associated with the second segment of third party video content.

20. The system of claim 15, wherein the third party content manager is further operable to receive a request to refer third party content to a second user, to determine whether the user has permission to refer the third party content to the second user, and to add the referred third party content to a third party content queue associated with the second user responsive to the user having permission to refer the third party content to the second user.
